(19) United States
(12) Patent Application Publication
(10) Pub. No.: US 2022/0394237 A1
(43) Pub. Date: Dec. 8, 2022

(54) TEST DEVICE

(71) Applicant: TRIPLE WIN TECHNOLOGY(SHENZHEN) CO.LTD., Shenzhen (CN)

(72) Inventors: YEN-SHENG LIN, New Taipei (TW); YING-QUAN ZHAO, Shenzhen (CN)

(21) Appl. No.: 17/566,614

(22) Filed: Dec. 30, 2021

(30) Foreign Application Priority Data
Jun. 8, 2021 (CN) 202121276183.1

(51) Int. Cl. H04N 17/00; H04N 5/225

(52) U.S. Cl. CPC H04N 17/002; H04N 5/2252; H04N 5/22521

(57) ABSTRACT

A test device which is convenient for fast testing of cameras being mass-produced and providing a test environment without contamination by reflected light, comprises a housing, a mounting member, a test card, and a light source assembly. The housing is a testing cavity and, at opposite ends, defines a testing hole and a light through hole lined up on center axis of the housing. A distance between an inner wall of the housing and the central axis gradually increases from the testing hole to the light through hole. The test card is arranged in the testing cavity. The light source assembly is connected to the mounting member and covers the light through hole. Sides of the housing illuminated by the light source assembly absorb all light emitted by the light source assembly.

### FIELD

The subject matter herein generally relates to test device for cameras, and more particularly to a test device for testing a light-receiving performance of a camera.

### BACKGROUND

There are two methods for testing optical performance of a camera. One method is that a single camera is directly installed in a test hole of a test device (a device used for testing the performance of an image-capturing device). However, such method is not suitable for mass-production. The other method is carrying the cameras on an assembly line one-by-one to a fixture, the fixture defines a window in which a test device is mounted. However, in such method, the complex internal structure of the fixture may reflect light emitted by the test device, and the test device may receive some external light entering through the window. A testing environment without reflected or external light is problematic, and an accuracy of testing is reduced.

### BRIEF DESCRIPTION OF THE DRAWINGS

Implementations of the present technology will now be described, by way of embodiment, with reference to the attached figures.

FIG. 1 is an isometric view of a first embodiment of a device configured for conducting optical tests according to the present disclosure.

FIG. 2 is an exploded, isometric view of the device of FIG. 1.

FIG. 3 is similar to FIG. 2, but viewed from another angle.

FIG. 4 is an isometric view of a second embodiment of a device according to the present disclosure.

FIG. 5 is an isometric view of a third embodiment of a device according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like.

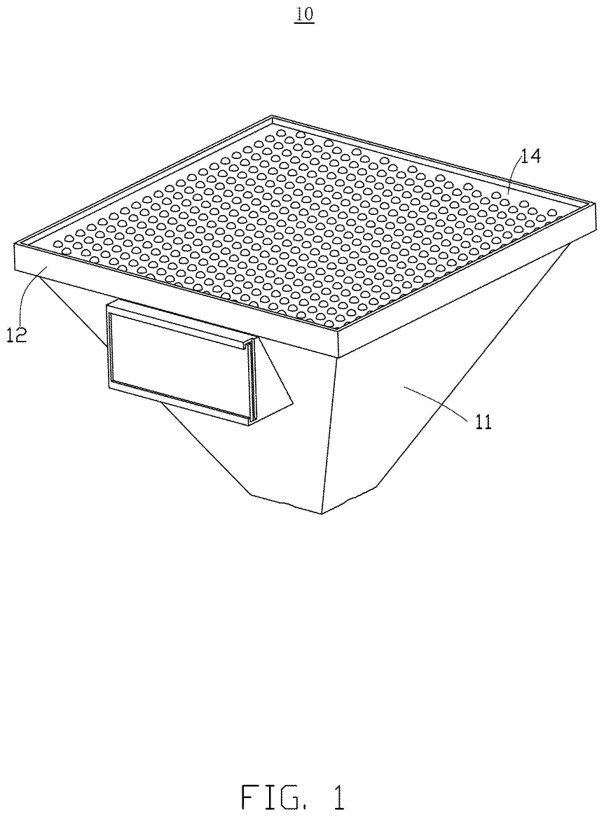

Referring to FIG. 1, a test device 100 of a first embodiment is illustrated. The test device 100 is configured to test optical performance of image-capturing device, such as a camera.

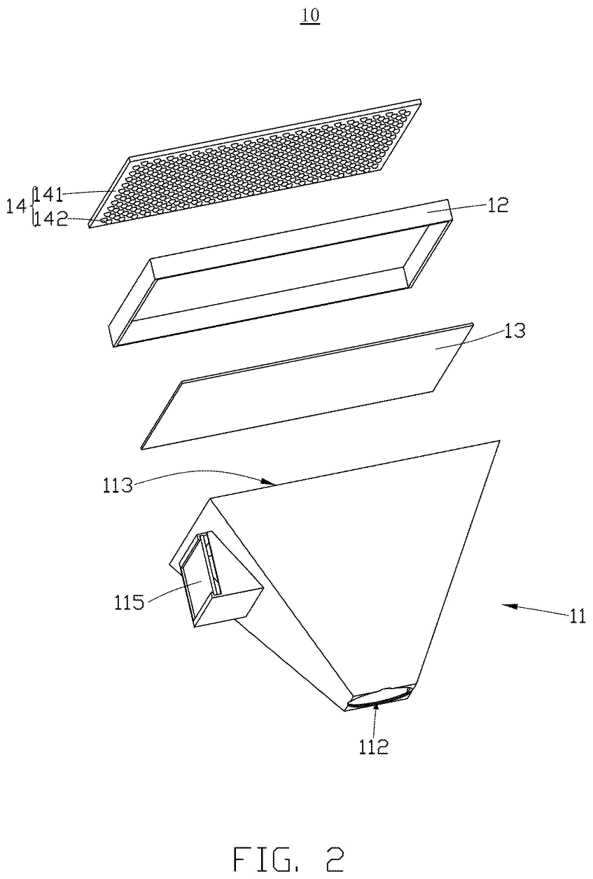

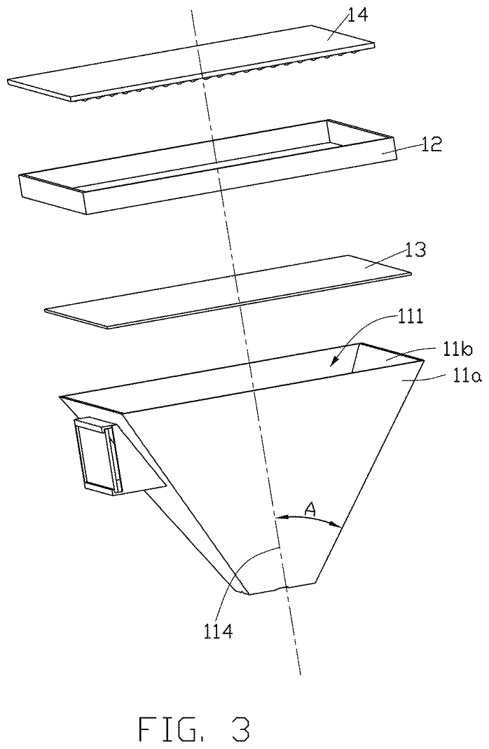

Referring to FIGS. 2 and 3, the test device 10 includes a housing 11, a mounting member 12, a test card 13, and a light source assembly 14. The housing 11 has a testing cavity 111 therein. The housing 11 includes opposite ends, one end of the housing 11 defines a testing hole 112 in which the camera being tested is mounted, and the other end of the housing 11 defines a through hole allowing the passage of light (light through hole 113). The testing hole 112, the testing cavity 111, and the light through hole 113 communicate in that order. A straight line defined by a center of the testing hole 112 and a center of the light through hole 113 is a central axis 114 of the housing 11. Along a direction from the testing hole 112 to the light through hole 113, a distance between an inner wall of the housing 11 and the central axis 114 gradually increases. The mounting member 12 is connected to the end of the housing 11 with the light through hole 113. The test card 13 is arranged in the testing cavity 111. The light source assembly 14 is connected to the mounting member 12 and covers the light through hole 113. The light source assembly 14 provides light of a certain brightness to the testing cavity 111, and a side of the housing 11 which is illuminated by the light source assembly 14 is configured to absorb the light emitted by the light source assembly 14. In this embodiment, an image-taking portion of the camera is mounted in the testing cavity 111 of the housing 11 through the testing hole 112.

In the test device 10, the distance between an inner wall of the housing 11 to the central axis 114 gradually increases along the direction from the testing hole 112 to the light through hole 113, so that the end of the housing with the testing hole 112 directly sleeves the camera. The test device 10 is matched with the camera. By moving the test device 10 on the camera, the test device 10 can be mounted on the camera. Therefore, the test device 10 is rendered suitable for testing mass-produced cameras as they are being produced. The side of the housing 11 illuminated by the light source assembly 14 is configured to absorb the light emitted by the light source assembly 14, so that the light from the light source is not reflected by the testing cavity 111, in the absence of reflected light, the test accuracy of performances of the camera is improved.

The housing 11 is substantially in a rectangular pyramid shape, the shapes of the test hole 112 and of the light through hole 113 are square. In other embodiments, the housing 11 may be other shape such as conical or the like.

The mounting member 12 is hollow and rectangular. An area of a plane where the hollow portion of the mounting member 12 is located is greater than or equal to an area of a plane where the light through hole 113 is located, so that the mounting member 12 connected to the housing 11 can cover the light through hole 113.

It is to be noted, an area of a plane where the test card 13 is located is greater than an area of a plane where the testing hole 112 is located, and the plane area of the test card 13 is less than an area of a plane where the light through hole 113 is located. In other words, a plane area of the test card 13 is greater than that of the testing hole 112 but less than that of the light through hole 113. The test card 13 may be connected to the mounting member 12 and fixed to the housing 11 through the mounting member 12.

In some embodiments, the housing 11 includes a plurality of stop plates 11a and a plurality of light absorbing layers 11b. The stop plates 11a surround and form the testing cavity 111. The light absorbing layers 11b are attached to inner sides of the stop plates 11a and are illuminated by the light source assembly 14, the light absorbing layers 11b absorb the light emitted by the light source device 14.

The stop plates 11a can be formed separately or as an integral unit. The light absorbing layers 11b can be directly coated on the inward-facing side of the stop plate 11a. The stop plates 11a can be metal plates, and the light absorbing layers 11b can be made of carbon nanotube blackbody material.

In some embodiments, the light absorbing layers 11b are detachably connected to the stop plates 11a, allowing replacement of light absorbing layers 11b which are aged or damaged.

In some embodiment, the light absorbing layers 11b may be pasted onto the stop plates 11a with a viscous water-soluble material.

In one embodiment, the housing 11 further defines an inspection window 115, which is located between the testing hole 112 and the light through hole 113. An intensity of light in the testing cavity 111 can be observed through the inspection window 115. Therefore, an intensity of light of the light source assembly 14 can be adjusted in time according to such intensity observed through the inspection window 115.

In some embodiments, an angle between a plane, where each of the stop plates 11a is located, and the central axis 114 is greater than or equal to 60°, therefore the entirety of the test card 13 can be within the field of view of the camera mounted in the testing hole 112.

In some embodiments, the light source assembly 14 includes a support plate 141 and a plurality of light sources 142. The support plate 141 is connected to the mounting member 12, the light sources 142 are installed on a side of the support plate 141 to face the test card 13 and are in an array. The array of light sources 142 provides uniform illumination and intensity of light for the test card 13, so that an accuracy in capturing an image of the test card 13 by the camera is made more precise.

In some embodiments, the housing 11 is made of a light absorbing material, which is convenient for the integrated forming of the housing 11, and a processing process is simplified.

In some embodiments, a light shielding member (not shown) is installed at the end of the housing 11 carrying the testing hole 112. The light shielding member can cover the camera installed in the testing hole 112.

The test device 10 can be applied to mass-produced cameras as they are being produced. For example, the mass-produced cameras are placed on fixtures in an assembly line flow, the end of the housing 11 with the testing hole 112 passes through a window on each of the fixtures in manual, the camera carried by the fixture is installed in the testing hole 112, and then a controller connected to the camera switches the camera to take images of the test card 13.

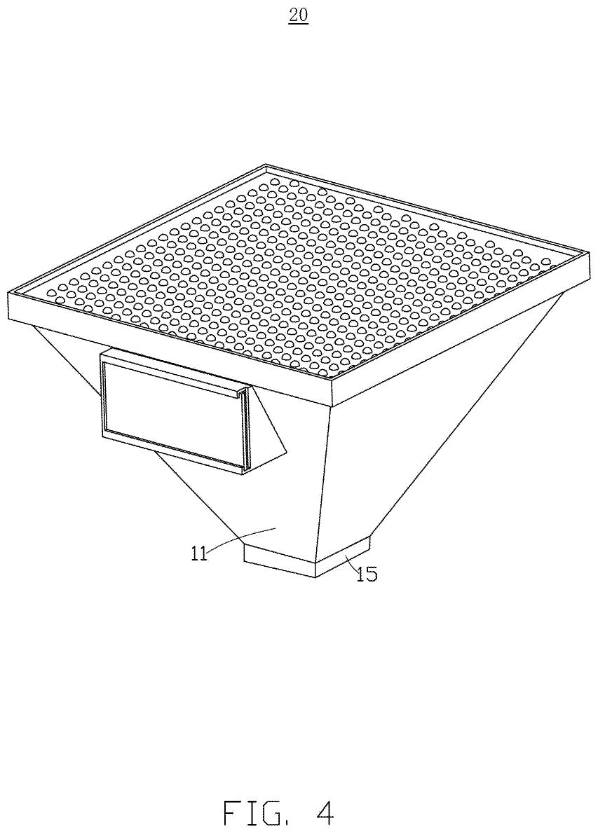

Referring to FIG. 4, a test device 20 of a second embodiment is illustrated. The test device 20 in the second embodiment is similar to the test device 10 in the first embodiment, and also includes the housing 11, the mounting member 12, the test card 13, and the light source assembly 14. A difference between the test device 20 and the test device 10 is that the housing 11 and the mounting member 12 of the test device 20 are made of flexible materials, and the test device 20 further includes a fixing member 15 connected to the end of the housing 11 with the testing hole 112. The fixing member 15 limits size of the testing hole 112.

Since the housing 11 and the mounting member 12 are made of flexible materials, the housing 11 can be deformed in a direction perpendicular to the central axis 114, the angle between the stop plate 11a of the housing 11 and the central axis 114 can be changed within the predetermined range, and the test device 20 can cooperate with a variety of fixtures carrying cameras, thereby an application range of the test device 20 is increased.

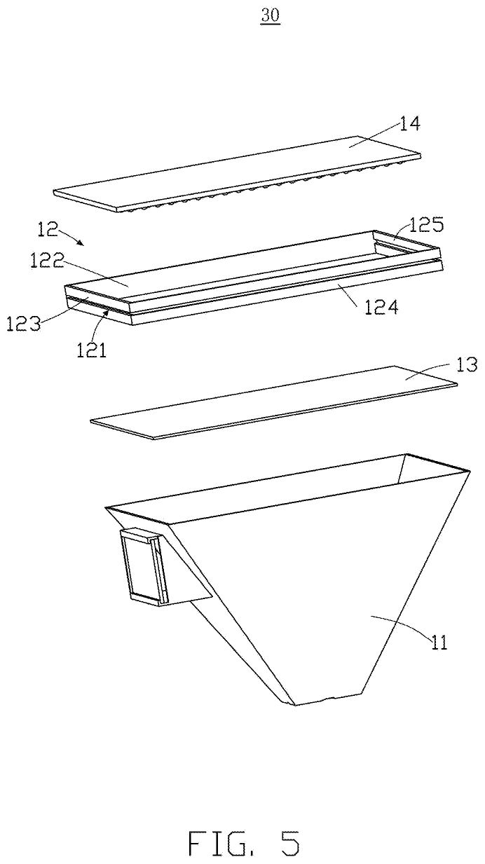

Referring to FIG. 5, a test device 30 of a third embodiment is illustrated. The test device 30 in the third embodiment is similar to the test device 10 in the first embodiment, and also includes the housing 11, the mounting member 12, the test card 13, and the light source assembly 14. A difference between the test device 30 and the test device 10 is that an end of the mounting member 12 of the test device 30 facing away from the light source assembly 14 defines a mounting groove 121, the mounting groove 121 penetrates a side face of the mounting member 12 and extends along a direction perpendicular to the center axis 114. The test card 13 engages with and is held in the mounting groove 121. Thereby, the test card 13 is detachably connected to the mounting member 12 through the mounting groove 121, which is convenient for allowing different test cards 13 to be used, an ability to test different cameras is extended.

The mounting member 12 is hollow and rectangular, and includes a first side face 122, a second side face 123, a third side face 124, and a fourth side face 125 which are connected in turn. The mounting groove 121 passes through the second side face 123, the third side face 124, and the fourth side face 125 along the circumference of the mounting member 12.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A test device comprising:
a housing comprising a testing cavity therein, a testing hole and a light through hole communicating with the testing cavity, wherein the testing hole is configured for mounting a camera, a straight line defined by a center of the testing hole and a center of the light through hole is a central axis of the housing, a distance between an inner wall of the housing and the central axis gradually increases along a direction from the testing hole to the light through hole;
a mounting member connected to an end of the housing with the light through hole;
a test card arranged in the testing cavity;
a light source assembly connected to the mounting member and covering the light through hole, wherein the light source assembly is configured to provide light of a certain brightness to the testing cavity, a side of the housing which is illuminated by the light source assembly is configured to absorb light.

2. The test device of claim 1, wherein the housing further comprises:
a plurality of stop plates surrounding the testing cavity, the testing cavity being formed by the plurality of stop plates; and
a plurality of light absorbing layers attached to inner sides of the plurality of stop plates, wherein the plurality of light absorbing layers are illuminated by the light source assembly and are configured to absorb the light emitted by the light source assembly.

3. The test device of claim 2, wherein the plurality of light absorbing layers are detachably connected to the plurality of stop plates.

4. The test device of claim 2, wherein the housing further defines an inspection window through which an intensity of light in the testing cavity is observed, the inspection window is located between the testing hole and the light through hole.

5. The test device of claim 2, wherein an angle between a plane, where each of the plurality of stop plates is located, and the central axis is greater than or equal to 60°.

6. The test device of claim 1, wherein the light source assembly comprises:
a support plate connected to the mounting member; and
a plurality of light sources mounted on a side of the support plate to face the test card, wherein the plurality of light sources are in an array.

7. The test device of claim 1, wherein the housing comprises a light absorbing material.

8. The test device of claim 1, wherein an end of the housing with the testing hole is provide with a light shielding member, the light shielding member is configured to cover the camera mounted in the testing hole.

9. The test device of claim 1, wherein the housing and the mounting member comprises flexible materials, the test device further comprises a fixing member connected to an end of the housing with the testing hole and is configured to limit size of the testing hole.

10. The test device of claim 1, wherein an end of the mounting member facing away from the light source assembly defines a mounting groove, the mounting groove penetrates a side face of the mounting member and extends along a direction perpendicular to the center axis, the test card engages with and is held in the mounting groove.
